(19) United States
(12) Patent Application Publication
(10) Pub. No.: US 2016/0049077 A1
(43) Pub. Date: Feb. 18, 2016

(54) Traffic Management System

(71) Applicant: Frogparking Limited, Palmerston North (NZ)

(72) Inventor: Donald H. Sandbrook, Palmerston North (NZ)

(73) Assignee: Frogparking Limited

(21) Appl. No.: 14/458,536

(22) Filed: Aug. 13, 2014

(51) Int. Cl. G08G 1/14

(52) U.S. Cl. CPC G08G 1/142

(57) ABSTRACT

A traffic management system for effectively guiding traffic. The traffic management system generally includes a gateway device in communication with a telecommunications network, a plurality of parking sensors in wireless communication with the gateway device, a management server in communication with the parking sensors via the telecommunications network, and at least one traffic management device in wireless communication with the gateway device. The management server determines the availability of parking spaces in a parking lot and identifies which traffic management device to activate to indicate the availability of the parking spaces within a zone.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a traffic management system and more specifically it relates to a traffic management system for effectively guiding traffic.

2. Description of the Related Art

Any discussion of the related art throughout the specification should in no way be considered as an admission that such related art is widely known or forms part of common general knowledge in the field.

In areas of high traffic density where parking is at a premium, it is often times difficult to find an available parking space. The driver of a vehicle wastes valuable time and becomes frustrated while driving around a parking lot to find a parking space. The additional searching for a parking space also compounds traffic congestion and has a negative impact on the environment by the extended operation of the vehicle.

To assist drivers in locating a parking space, conventional occupancy indicators have been recently developed that indicate whether an individual parking space is available. Conventional occupancy indicator systems are comprised of a visual indicator (e.g. a light) that is mounted in each individual parking space (typically to the ceiling or wall of an indoor vehicle parking structure) and a sensor that detects the presence of a vehicle within the individual parking spot. The occupancy indicator is directly wired to the sensor to allow for communications from the sensor to the occupancy indicator. The occupancy indicator and sensor are further wired to a central parking management system that communicates with the devices and also provides electrical power to the devices.

While conventional occupancy indicators assist in guiding drivers to available parking spaces in a parking lot, they are relatively expensive and difficult to install because of the required wiring of the devices together. Another problem with conventional occupancy indicators is that they are typically capable of only indicating the availability of individual parking spaces and are typically utilized only in indoor vehicle parking structures. In addition, a limitation of conventional occupancy indicators is that they are limited to indicating the availability of individual traffic spaces and are not adaptable for directing traffic over broader areas.

Because of the inherent problems with the related art, there is a need for a new and improved traffic management system for effectively guiding traffic.

### BRIEF SUMMARY OF THE INVENTION

The invention generally relates to a traffic management system which includes a gateway device in communication with a telecommunications network, a plurality of parking sensors in wireless communication with the gateway device, a management server in communication with the parking sensors via the telecommunications network, and at least one traffic management device in wireless communication with the gateway device. The management server determines the availability of parking spaces in a parking lot and identifies which traffic management device to activate to indicate the availability of the parking spaces within a zone.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of the present invention.

FIG. 2 is a top view of a parking lot with the present invention installed and in operation indicating a zone having one or more available parking spaces.

FIG. 3 is a block diagram of the traffic management device.

FIG. 4 is an upper perspective view of the traffic management device.

FIG. 5 is an exploded upper perspective view of the traffic management device.

FIG. 6 is a top view of the traffic management device.

FIG. 7 is a bottom view of the traffic management device.

FIG. 8 is an end view of the traffic management device.

FIG. 9 is a cross sectional view taken along line 9-9 of FIG. 6.

FIG. 10 is a cross sectional view taken along line 10-10 of FIG. 6.

FIG. 11 is a cross sectional view of an alternative embodiment of the traffic management device having two opposing indicator lights at the opposing ends of the housing.

### DETAILED DESCRIPTION OF THE INVENTION

### A. Overview.

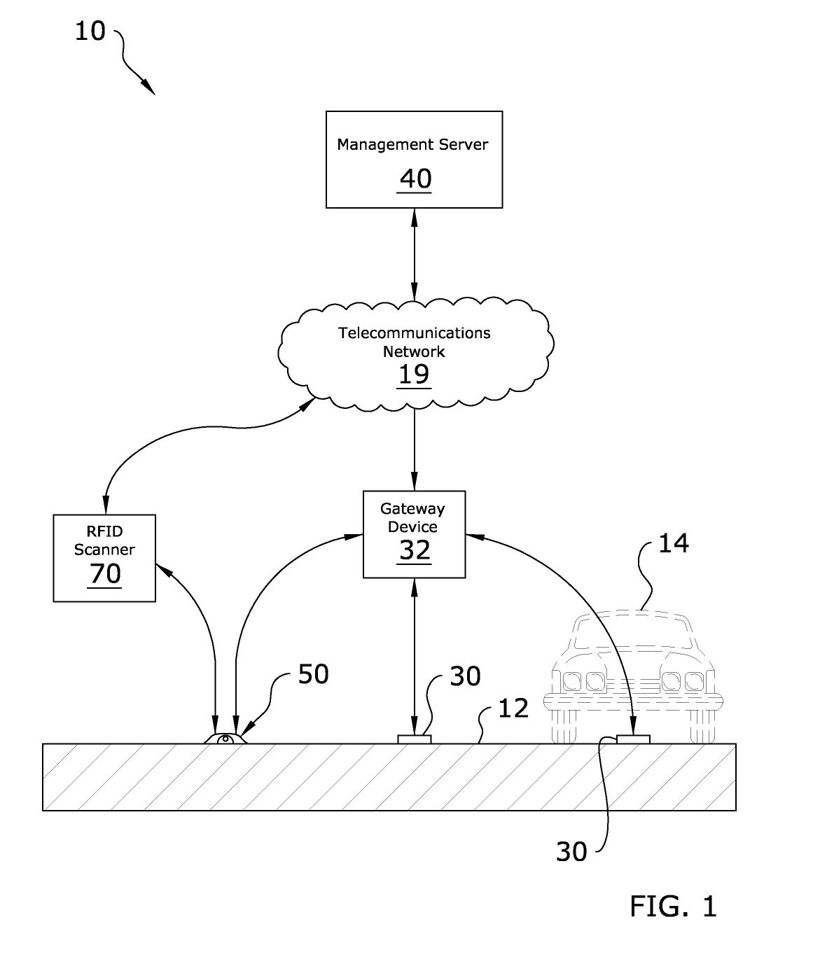

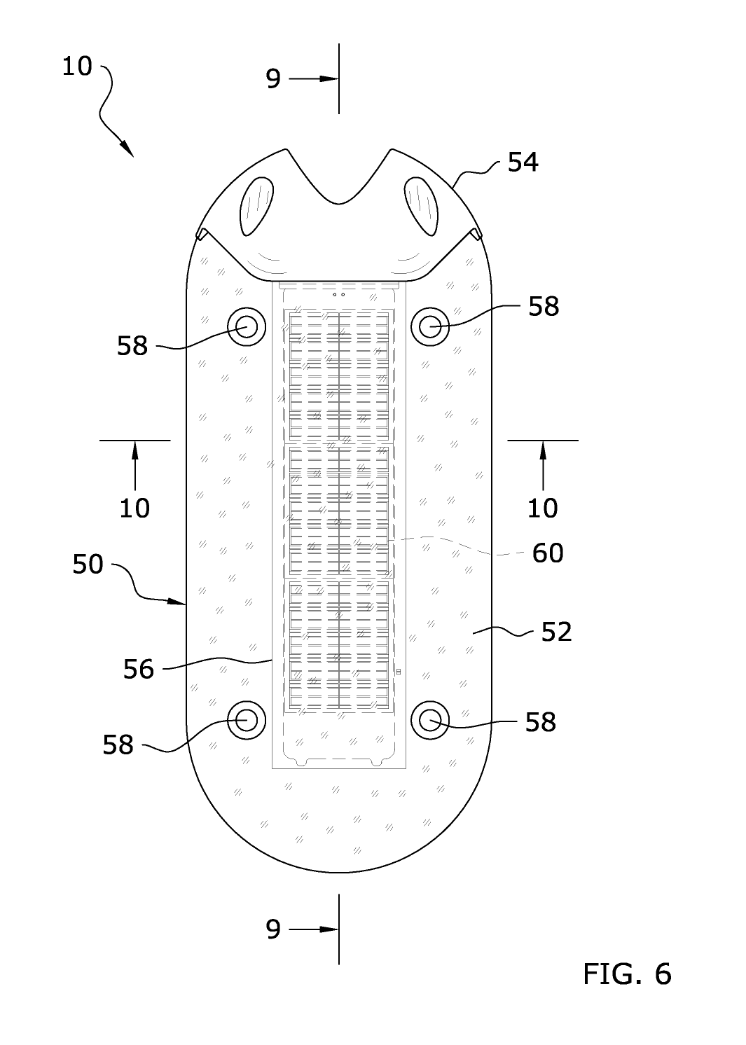

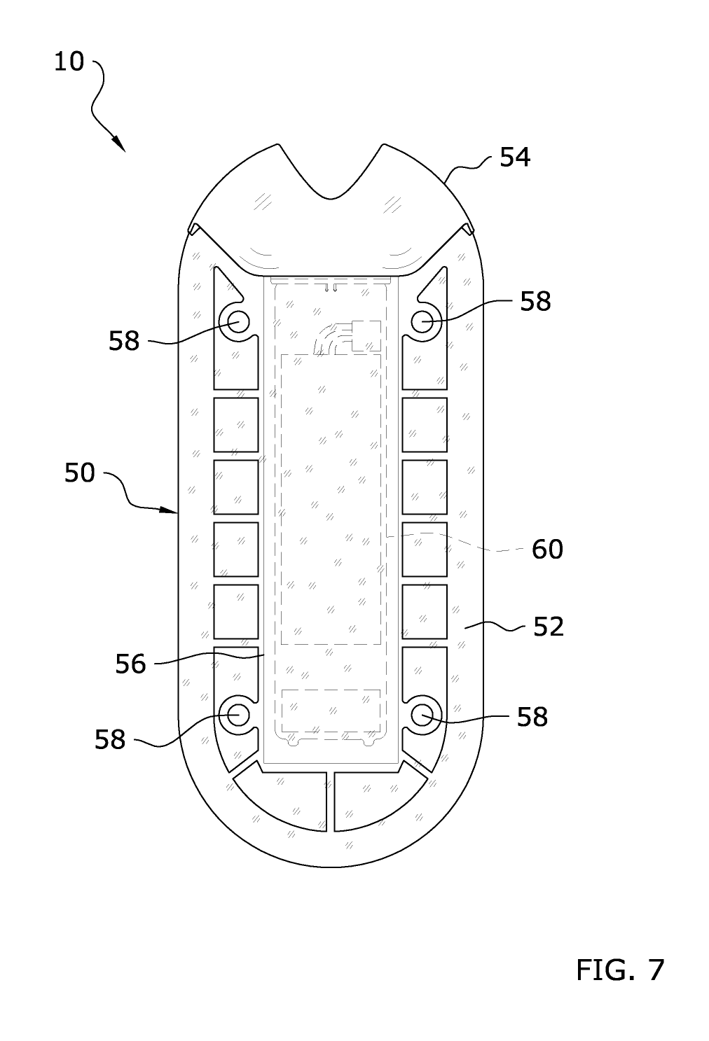

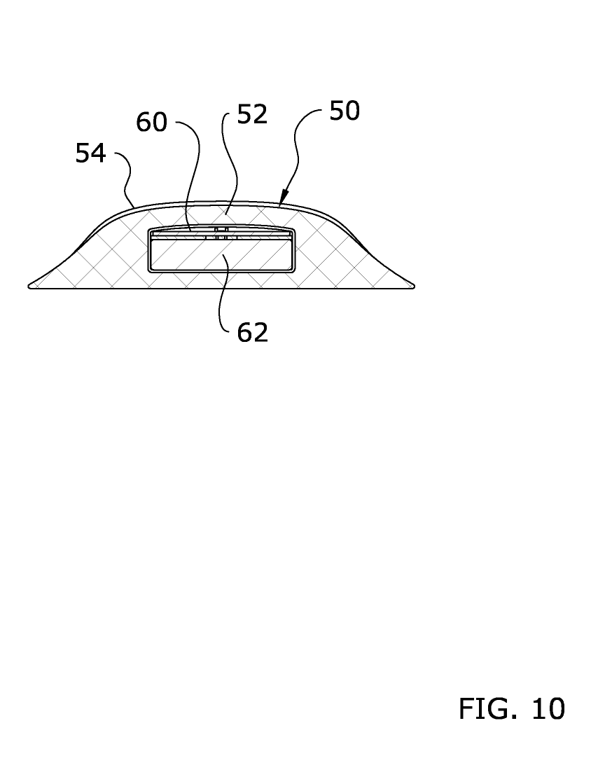

Turning now descriptively to the drawings, in which similar reference characters denote similar elements throughout the several views, FIGS. 1 through 10 illustrate a traffic management system 10, which comprises a gateway device 32 in communication with a telecommunications network 19, a plurality of parking sensors 30 in wireless communication with the gateway device 32, a management server 40 in communication with the parking sensors 30 via the telecommunications network 19, and at least one traffic management device 50 in wireless communication with the gateway device 32. The management server 40 determines the availability of parking spaces 11 in a parking lot and identifies which traffic management device 50 to activate to indicate the availability of the parking spaces 11 within a zone. The present invention is designed to be utilized across a plurality of parking lots each having a plurality of parking spaces 11 in various locations around the world. To avoid the expense and difficulty of wiring the traffic management devices 50, the traffic management devices 50 are in wireless communication with the management server 40 through a gateway device 32 or other wireless communication system.

### B. Telecommunications Network.

The present invention may be utilized upon any telecommunications network 19 capable of transmitting data including voice data and other types of electronic data. Examples of suitable telecommunications networks 19 for the present invention include but are not limited to global computer networks (e.g. Internet), wireless networks, cellular networks, satellite communications networks, cable communication networks (via a cable modem), microwave communications network, local area networks (LAN), wide area networks (WAN), campus area networks (CAN), metropolitan-area networks (MAN), and home area networks (HAN). The present invention may communicate via a single telecommunications network 19 or multiple telecommunications networks 19 concurrently. Various protocols may be utilized by the electronic devices for communications such as but not limited to HTTP, SMTP, FTP and WAP (Wireless Application Protocol). The present invention may be implemented upon various wireless networks such as but not limited to 3G, 4G, LTE, CDPD, CDMA, GSM, PDC, PHS, TDMA, FLEX, REFLEX, IDEN, TETRA, DECT, DATATAC, and MOBITEX. The present invention may also be utilized with online services and internet service providers.

The Internet is an exemplary telecommunications network 19 for the present invention. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

### C. Management Server.

The present invention includes a management server 40 that is in communication with the parking sensors 30 and the traffic management devices 50. The management server 40 may be comprised of any computer, Internet-based computer, cloud based computer, virtual computer, home computer or other computer system capable of receiving and transmitting data via IP networks and the telecommunication networks. The management server 40 may be comprised of any electronic system capable of receiving, storing, calculating and transmitting information (e.g. computer data, etc.).

The management server 40 is utilized in the present invention to receive, store and transmit organization account data, user account data, parking lot data (e.g. geographical location of the parking lot), individual parking space 11 data (e.g. the location of the parking space 11, the parking lot the parking space 11 is part of, the zone the parking space 11 is located in), data to and from the parking sensors 30 (e.g. whether or not a vehicle 14 is present within the parking space 11), data to and from the traffic management devices 50 (e.g. instructions on what type of visual alert to activate for each individual traffic management device 50 if any, current weather conditions detected by the traffic management device 50) and the like.

### D. Parking Sensors.

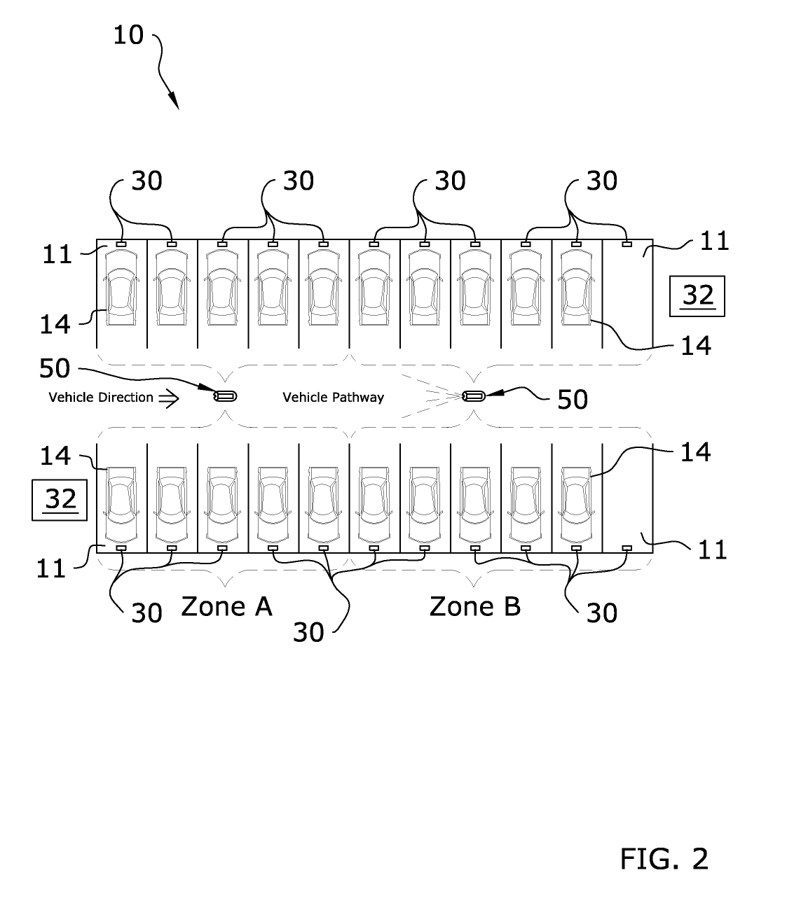

A plurality of parking sensors 30 are in wireless communication with one or more gateway devices 32 as illustrated in FIGS. 1 and 2 of the drawings. The plurality of parking sensors 30 are within a parking lot for vehicles 14 and more particularly are located within each individual parking space 11 of the parking lot as illustrated in FIG. 2 of the drawings. Each of the parking sensors 30 is associated with a specific parking space 11 and a specific zone that the parking space 11 is part of to help the management server 40 determine what traffic management devices 50 to activate or deactivate.

FIG. 2 of the drawings illustrates an example of a parking lot having a plurality of parking spaces 11 each having a generally rectangular shape with parking indicia (e.g. painted lines) defining at least a portion of the boundaries of the parking spaces 11. While parking lots typically are comprised of rows of parking spaces 11, it can be appreciated that the parking lot may have various configurations or a parking lot may be comprised of single parking space 11. Each parking space 11 preferably is assigned a parking identifier (e.g. serial number, code) that is utilized to identify each of the parking spaces 11 in the database of the management server 40, wherein the parking identifier is stored within a sensor database of the management server 40.

Each parking space 11 preferably includes a parking sensor 30 to detect the presence of a vehicle 14 in each respective parking space 11. The parking sensor 30 may be positioned in various locations of an individual parking space 11, however, it is preferable that the parking sensor 30 be positioned approximately 2 meters from the front end of the parking space 11 to be positioned under a parked vehicle 14. The parking sensor 30 may also detect the presence of the permit device utilizing wireless communications between the parking sensor 30 and the permit device (e.g. the permit device may emit a Bluetooth low energy signal that is detected by the parking sensor 30).

The parking sensor 30 is able to detect the presence of a vehicle 14 in the associated parking space 11 for the parking sensor 30 without mistaking a human or pet walking through the parking space 11 as a vehicle 14. Furthermore, the parking sensor 30 preferably does not notify the management server 40 of a vehicle 14 parked in the parking space 11 until after a period of time (e.g. 5 seconds or more) that a vehicle 14 is stationary within the parking space 11 and/or within a specific distance of the parking sensor 30 (e.g. less than 2 feet from the parking sensor 30 when the parking sensor 30 is positioned at the front end of the parking a space. The parking sensor 30 may detect the presence of the vehicle 14 utilizing various types of object presence detection systems such as but not limited to proximity sensors (e.g. RF radiation, light, optical, sound, capacitive, magnetic, inductive proximity sensors), motion sensors (e g infrared, ultrasonic, microwave sensors, video), a weight sensor in the parking surface 12 of the parking space 11 and the like.

The parking sensors 30 preferably communicate with the management server 40 via a telecommunications network 19 to indicate that a vehicle 14 is parked in the parking space 11. The parking sensors 30 may access the telecommunications network 19 directly or via a gateway device 32 (e.g. wireless router, general packet radio service modem a.k.a. GPRS modem). The parking sensors 30 may be in communication with the gateway device 32 via a wired connection or wireless connection (e.g. Wi-Fi, Bluetooth and the like). The parking sensors 30 may include a wired connection to an electrical power supply, a battery and/or a solar power system for providing electrical power to the parking sensors 30.

### E. Gateway Devices.

FIGS. 1 and 2 illustrate the usage of one or more gateway devices 32 which are in communication with the telecommunications network 19. The gateway devices 32 are preferably in wired communication with the telecommunications network 19 but may also be in wireless communication with the telecommunications network 19. The gateway devices 32 may be comprised of any device capable of receiving and transmitting wireless data signals (e.g. wireless router) to various electronic devices including the parking sensors 30 and the traffic management devices 50. The gateway devices 32 may be positioned in any location in or around the parking lot capable of communicating with the parking sensors 30 and the traffic management devices 50. FIG. 2 illustrates the gateway devices 32 being located at the opposing ends of two rows of parking spaces 11 within a parking lot, but the gateway devices 32 may be located in various other locations.

### F. Traffic Management Device.

FIGS. 1 through 9 illustrate the traffic management device 50 utilized to provide visual alerts (e.g. illumination of a particular light and/or pattern of light). The traffic management device 50 is comprised of a housing 52 that is preferably designed and adapted to be positioned within the main drive path within a parking lot. In particular, the traffic management device 50 is designed to be attached directly to the parking surface 12 via fasteners 16, adhesive members 17 or the like. The traffic management device 50 may be positioned within a recessed portion of the pathway in the parking lot or directly on the normal parking surface 12 of the parking lot. The traffic management device 50 preferably has a low profile to not interfere with the vehicles 14 or pedestrians that pass over the device.

Furthermore, the traffic management device 50 is capable of being driven over by a motorized vehicle 14 (e.g. a car, pickup, truck) without damaging the traffic management device 50. The traffic management device 50 is also preferably waterproof to withstand rain and other water environments.

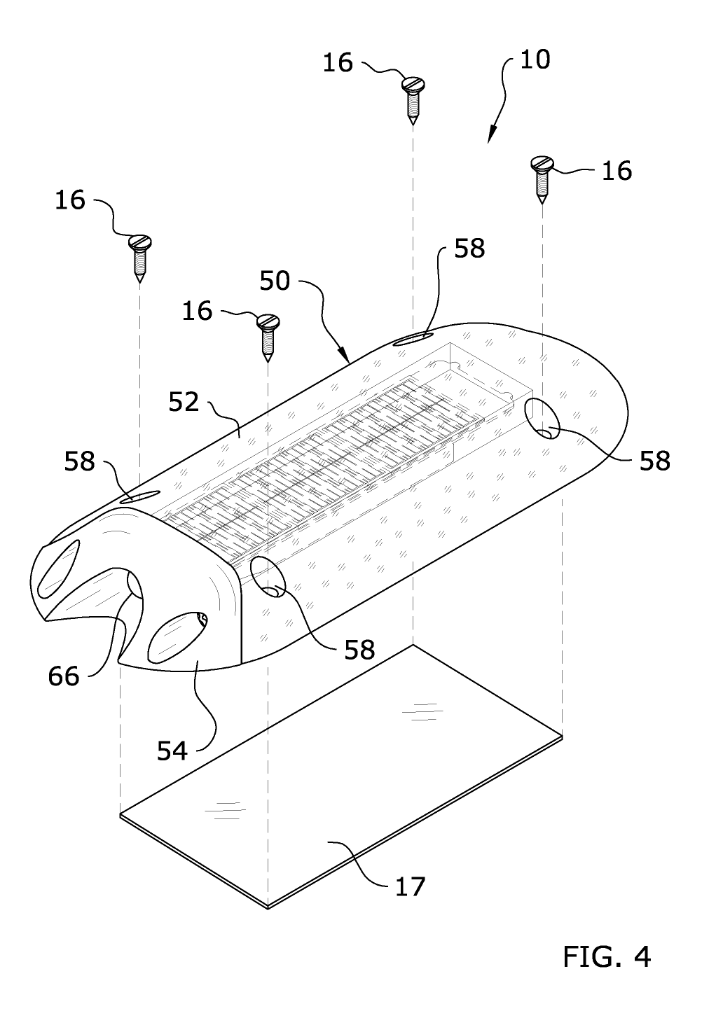

FIGS. 4 through 9 illustrate the housing 52 of the traffic management device 50. The housing 52 is preferably transparent or semi-transparent to allow for the entry of sunlight to the solar panel 60 and for the illumination to provide a visual alert to drivers of vehicles 14.

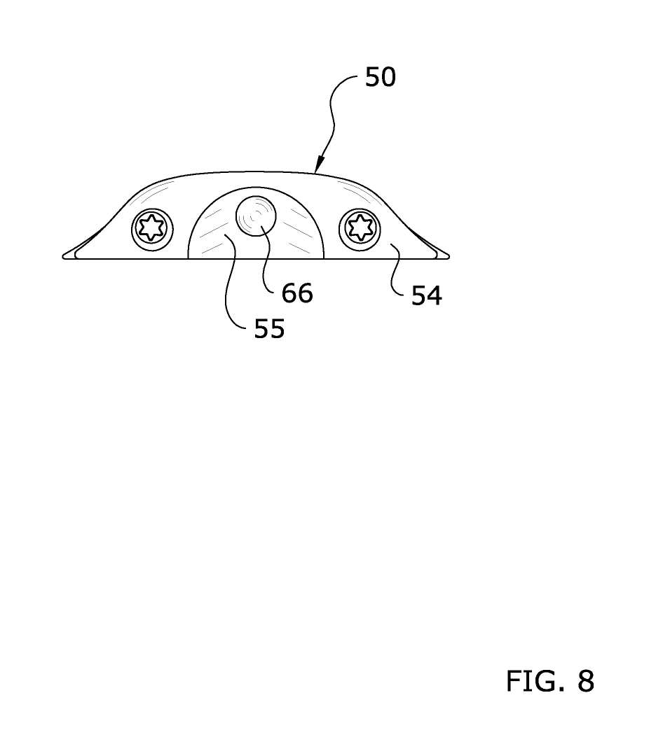

The housing 52 preferably has a tapered first side and a tapered second side with a relatively flat upper middle portion as illustrated in FIG. 8 of the drawings. The housing 52 is preferably constructed of a rigid plastic material that is transparent or semi-transparent.

The housing 52 preferably includes a plurality of apertures 58 within the corner portions of the housing 52. The apertures 58 receive corresponding fasteners 16 (e.g. threaded bolts or masonry anchor screws) that extend into the parking surface 12 of the parking lot to secure the traffic management device 50 to the parking surface 12. In addition to or separate from the apertures 58 with fasteners 16 to secure the housing 52, the usage of an adhesive member 17 attached to the flat bottom surface of the housing 52 may be utilized to secure the housing 52 of the traffic management device 50 to the parking surface 12.

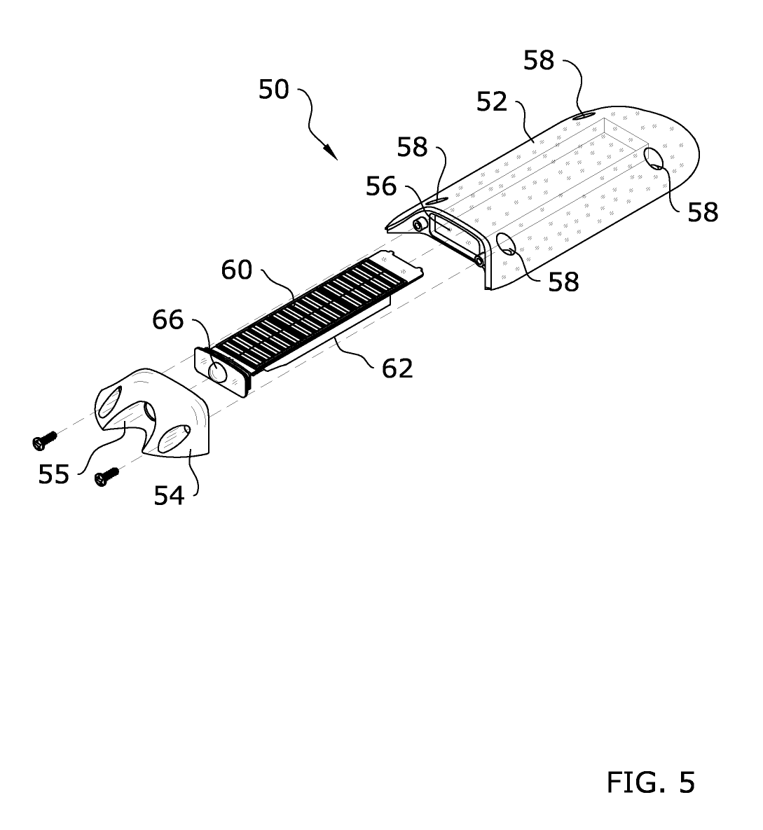

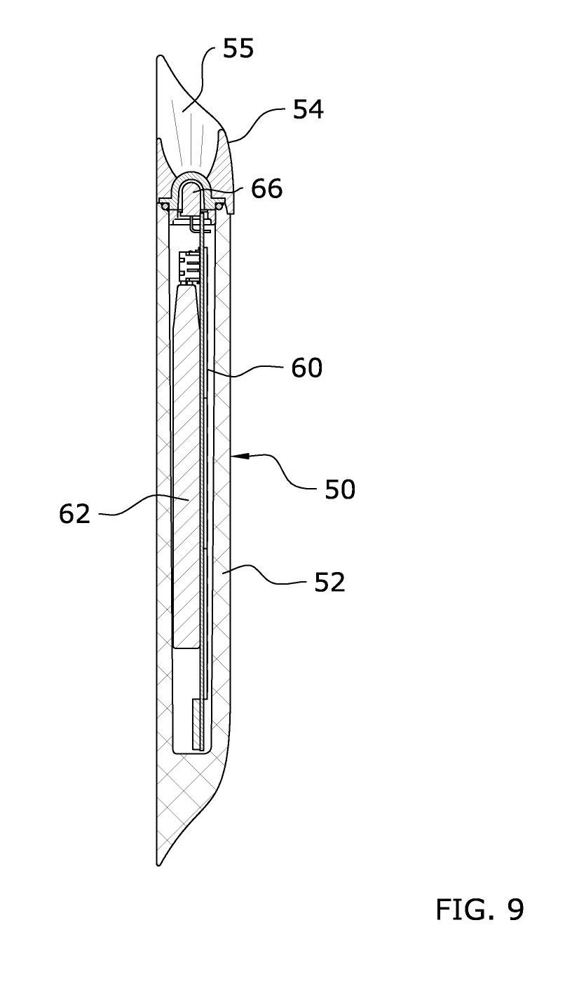

The housing 52 has an end cap 54 that is removable from the main body of the housing 52 exposing an interior cavity 56 that receives and stores the various electronic components of the traffic management device 50. The end cap 54 is preferably a shroud for the indicator light 66 to help direct the light and the end cap 54 is preferably opaque or reflective to direct the light emitted from the indicator light 66 in a specific direction. For example, the solar panel 60 is an elongated and flat structure that is preferably near the upper surface of the interior cavity 56 to provide the maximum level of exposure to sunlight for recharging the energy storage device 62 when inserted as illustrated in FIGS. 4 and 9 of the drawings. The energy storage device 62 is further comprised of an elongated flat structure that is attached to the lower surface of the solar panel 60 and is inserted into the open end of the interior cavity 56 as illustrated in FIG. 5 of the drawings.

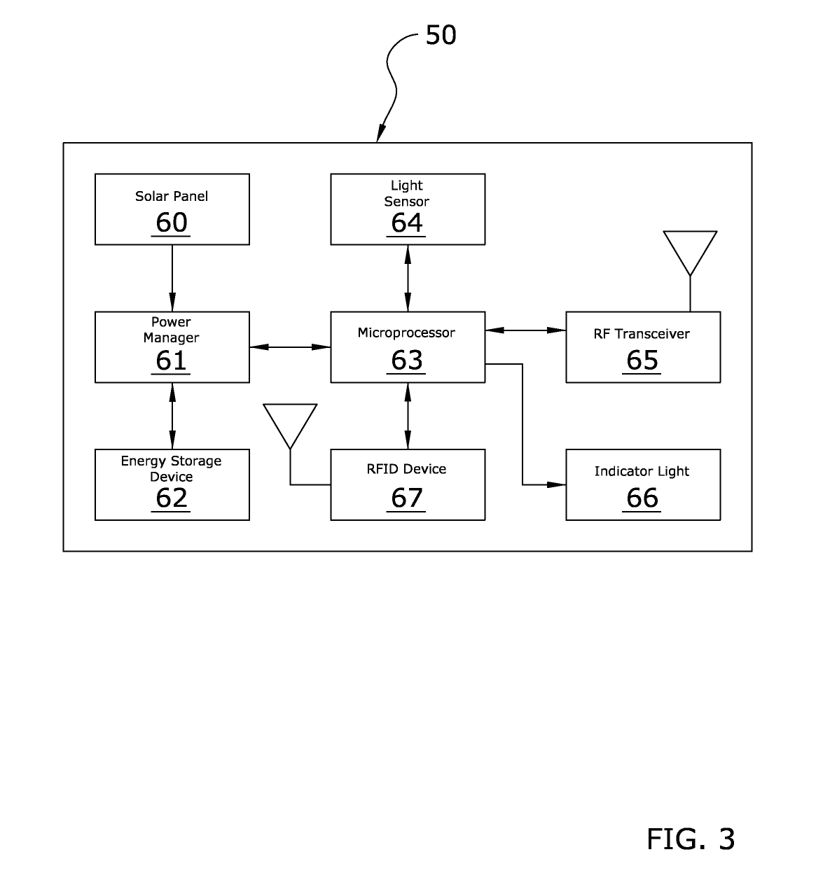

The traffic management device 50 may include a printed circuit board (PCB) or other electronic device. As shown in FIG. 3 of the drawings, the traffic management device 50 includes a microprocessor 63 that receives, calculates, stores and transmits data. The microprocessor 63 includes memory that stores the device identifier, parking zone identifier and other parking related information. The information stored within the traffic management device 50 may be wirelessly transmitted to the management server 40, an RFID scanner 70 or the gateway device 32.

The traffic management device 50 further preferably includes RFID capability that allows for the RFID scanner 70 to identify the device identifier and other parking space 11 information by scanning the traffic management device 50. The RFID device 67 within the traffic management device 50 may be active or passive. Furthermore, the RFID device 67 (including the memory within the RFID device 67) is preferably in bidirectional communication with the microprocessor 63 so that the RFID memory may be reprogrammed by the microprocessor 63 as needed to update a device identifier, user information or other related data.

The traffic management device 50 further preferably includes an energy storage device 62 (e.g. battery) that is electrically connected to the microprocessor 63 and other components of the traffic management device 50 to provide electrical power. The energy storage device 62 may be removable and/or rechargeable. The energy storage device 62 is preferably electrically recharged by a solar panel 60 with a power manager 61 as further shown in FIG. 3 of the drawings. Recharging by the solar panel 60 prevents the user from having to periodically replace the energy storage device 62 and extends the useful life thereof. The power manager 61 controls the charging of the energy storage device 62 to ensure proper charging.

The traffic management device 50 further includes a light sensor 64 that detects the level of ambient light and communicates the light level data to the microprocessor 63. Based upon the level of ambient light, the microprocessor 63 determines the level of output light the indicator light 66 must provide to be effectively viewed by drivers while reducing the amount of electrical power used to illuminate the indicator light 66 (e.g. in dark ambient conditions, the amount of light emitted from the indicator light 66 is significantly less than in bright ambient conditions).

The traffic management device 50 also includes an RF transceiver 65 that wirelessly communicates wirelessly with the gateway device 32 and/or the telecommunications network 19 acting as a communications gateway between the traffic management device 50 and the management server 40. The RF transceiver 65 may communicate via various wireless technologies such as but not limited to Wi-Fi, Bluetooth and the like.

The traffic management device 50 includes at least one indicator light 66 that is directed towards the oncoming traffic within a parking light. The indicator light 66 is preferably positioned within a distal end of the housing 52 of the traffic management device 50 as illustrated in FIGS. 4, 8 and 9 of the drawings. The distal end of the housing 52 includes a light passage 55 that is outwardly tapered from the indicator light 66 to guide and focus the light emitted from the indicator light 66 to be directed towards oncoming vehicles 14.

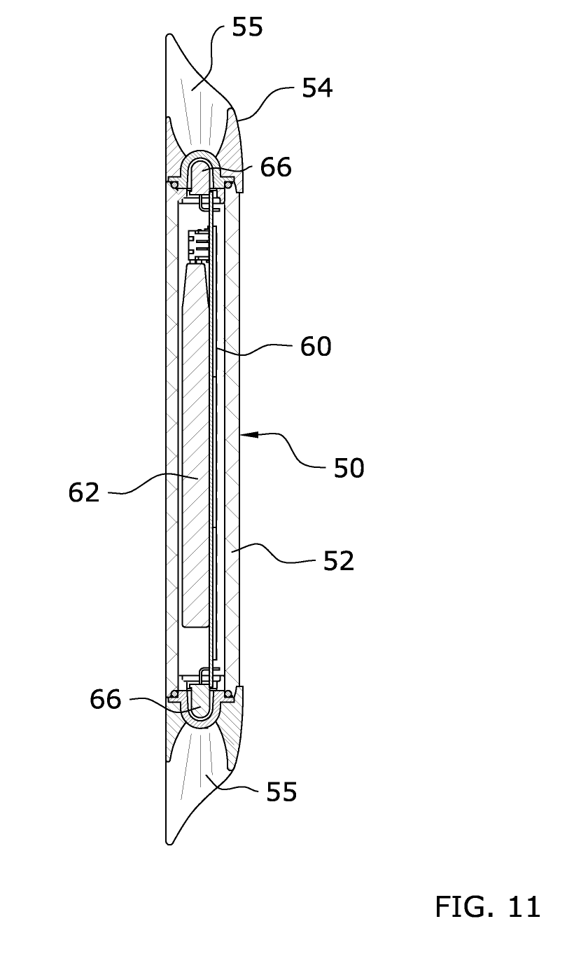

As illustrated in FIG. 11 of the drawings, the traffic management device 50 may include two indicator lights 66 within the opposing ends of the housing 52 to provide a visual indication of parking availability to traffic coming from both directions within a pathway within a parking lot. Each of the indicator lights 66 are in communication with the microprocessor 63 and may display the same type of light or a different type of light.

The indicator light 66 is in electrical communication with the microprocessor 63 wherein the microprocessor 63 controls the illumination of the indicator light 66. The indicator light 66 is preferably comprised of a light emitting diode (LED) that may change colors (e.g. red, yellow, green, blue, orange), have different light patterns (e.g. flashing light, different flashing patterns of light, constant light), different light intensity/brightness and other characteristics of light that may be controlled and changed by the microprocessor 63 based upon the traffic conditions. The different colors may be achieved through the use of multiple single color LED's.

### G. Operation and Functionality of Invention.

FIG. 2 illustrates a first traffic management device 50 and a second traffic management device 50 in wireless communication with the gateway devices 32. The traffic management devices 50 are each associated with a zone (FIG. 2 illustrates Zone A associated with the traffic management device 50 on the left side of the parking lot and Zone B associated with the traffic management device 50 on the right side of the parking lot). Zone A is associated with the plurality of parking spaces 11 on the left side of the parking lot as indicated and Zone B is associated with the plurality of parking spaces 11 on the right side of the parking lot as indicated. The parking spaces 11 associated with each zone are preferably on opposing sides of the pathway.

Each traffic management device 50 is activated (or deactivated) to provide an availability visual alert when the associated zone has at least one free parking space 11. The traffic management device 50 preferably is associated with a zone of parking spaces 11 such as 8 or more parking spaces 11 per each traffic management device 50. The installation of the traffic management devices 50 is where drivers will be able to easily view the indicator light 66, preferably in the middle of the pathway of the parking lot as illustrated in FIG. 2 of the drawings. The traffic management device 50 preferably does not have any detection or sensor system to detect the presence of vehicles 14 and instead relies upon the parking sensors 30 in communication with the management server 40.

With the traffic management device 50 mounted on the parking surface 12 (or a road surface), the sunlight during daytime hours passes through the transparent housing 52 to the solar panel 60 and the electrical power generated by the solar panel 60 is used to recharge the energy storage device 62 and operate the indicator light 66. During dark light conditions, the indicator light 66 is provided electrical power by the energy storage device 62. In addition, the traffic management device 50 may be programmed or controlled to only operate during specific times of day when needed (e.g. from the hours of 10 am to 9 pm for a parking lot in a business area where the businesses are only open from 10 am to 9 pm).

FIG. 2 illustrates that Zone A does not include any free parking spaces 11 available to park in while Zone B has two free parking spaces 11 to park a vehicle 14 in. Since there are no available parking spaces 11 in Zone A, the traffic management device 50 associated and located within Zone A is not activated and does not provide any visual alert to conserve electrical power (alternatively, the traffic management device 50 could provide an unavailable visual alert comprised of a red light or other visual indicator indicating the lack of availability of a parking space 11). Since Zone B has two parking spaces 11 available to park in, the management server 40 is notified of the availability by the parking sensors 30 and the management server 40 then communicates with the traffic management device 50 in Zone B to activate a visual alert (e.g. a green light, a flashing or constant light). Drivers of vehicles 14 can visually see the visual alert from the traffic management device 50 in Zone B and therefore know there is at least one parking space 11 available to them in Zone B. If a parking space 11 becomes available in Zone A, the management server 40 is notified of the same by the corresponding parking sensor 30 and the management server 40 then communicates to the corresponding traffic management device 50 wirelessly through the gateway device 32 to activate a visual indicator indicating the availability of at least one parking space 11. If both of the empty parking spaces 11 in Zone B are filled with vehicles 14, the parking sensors 30 notify the management server 40 and the management server 40 correspondingly deactivates the illumination of the indicator light 66 from the corresponding traffic management device 50 in the corresponding zone (or changes the characteristics of the indicator light 66 such as using a red light).

The indicator light 66 may be illuminated in various light types (e.g. color, light patterns, light intensity and the like) depending upon the availability and/or unavailability of parking spaces 11 in the associated zone of parking spaces 11. The color may be changed to reflect the approximate percentage of availability within the zone associated with the traffic management device 50 (e.g. green light for high availability, yellow light for limited availability, red light for no available parking spaces 11, no light for no available parking spaces 11). While green and red lights are the preferred visual indicators provided by the traffic management device 50, different lights may be utilized for other types of information (e.g. blue light for a reserved parking space 11 or handicapped parking space 11 being available, orange light for an emergency situation, flashing white light for high traffic areas to warn drivers). The light illuminated from the indicator light 66 may also flash differently based upon availability (e.g. no flashing for high availability, fast flashing for limited availability).

In another embodiment, to conserve electrical power stored within the energy storage device 62 it is important to not activate the traffic management device 50 and the corresponding indicator light 66 unless there is a minimum number of taken (i.e. unavailable) parking spaces 11 within the zone. It is preferable that the traffic management device 50 does not provide any visual alerts to conserve electrical power unless at least forty-percent or more of the parking spaces 11 in the zone are filled with vehicles 14. The purpose of not activating the traffic management device 50 unless a minimum number of parking spaces 11 in the zone are unavailable is to reduce power consumption when drivers of vehicles 14 can easily see there is a high percentage of availability of parking spaces 11 in the zone (e.g. greater than sixty-percent availability). It is also preferable to blink the indicator light 66 (preferably comprised of an LED) at a suitable frequency in a flashing manner to utilize less electrical power even when providing a visual indication that parking spaces 11 are available in the zone (e.g. flashing a green light with the indicator light illuminated in green light for 1 second, then turned off for 1 second, then turned on for 1 second and so forth).

The present invention may also be utilized in areas outside of parking lots such as on roads to provide hazardous conditions (e.g. icy roads, traffic congestion and delays, accident ahead, road construction ahead) thereby providing advanced warning to motorists to improve safety and reduce the risk of an accident. In these types of areas, the traffic management device 50 may be in communication with the management server 40 or since most of the roadway may be in an area without a telecommunications network 19 the traffic management device 50 may be activated, deactivated and controlled by the RFID scanner 70 instead in a manual manner by an individual. The traffic management device 50 may also be temporarily attached to the road surface.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A traffic management system, comprising:
a gateway device in communication with a telecommunications network;
a plurality of parking sensors in wireless communication with said gateway device, wherein said plurality of parking sensors are within a parking lot for vehicles;
a management server in communication with said plurality of parking sensors; and
a first traffic management device in wireless communication with said gateway device, wherein said first traffic management device is associated with a first zone within said parking lot, wherein said first zone is comprised of a plurality of first parking spaces, wherein said first traffic management device is adapted to provide a visual indication of availability of said plurality of first parking spaces within said first zone.

2. The traffic management system of claim 1, wherein said management server is in communication with said plurality of parking sensors via said telecommunications network.

3. The traffic management system of claim 1, wherein said telecommunications network is comprised of a global computer network.

4. The traffic management system of claim 1, wherein said telecommunications network is comprised of a local area network.

5. The traffic management system of claim 1, wherein said management server is comprised of a web based computer server.

6. The traffic management system of claim 1, wherein said plurality of parking sensors are each associated with a parking space within said parking lot.

7. The traffic management system of claim 1, wherein said first traffic management device is activated to provide an availability visual alert when said first zone has at least one free parking space.

8. The traffic management system of claim 7, wherein said availability visual alert is comprised of an indicator light within said first traffic management device being illuminated.

9. The traffic management system of claim 8, wherein said indicator light is illuminated with a first light type when said first zone has at least one free parking space and wherein said indicator light is illuminated with a second light type when said first zone has no free parking space.

10. The traffic management system of claim 8, wherein said first light type is comprised of a first color, wherein said first color is different from a second color of said second light type.

11. The traffic management system of claim 8, wherein said first light type is comprised of a first flashing pattern, wherein said first flashing pattern is different from a second flashing pattern of said second light type.

12. The traffic management system of claim 1, including a second traffic management device associated with a second zone within said parking lot.

13. The traffic management system of claim 12, wherein said second zone is comprised of a plurality of second parking spaces, wherein none of said first parking spaces are comprised of any of said second parking spaces.

14. The traffic management system of claim 1, wherein said first traffic management device is only activated when said first zone has at least a minimum number of unavailable parking spaces.

15. The traffic management system of claim 1, wherein said first traffic management device is only activated when at least forty-percent of said first zone is comprised of unavailable parking spaces.

16. The traffic management system of claim 1, wherein said first traffic management device is activated to provide an availability visual alert when said first zone includes at least one free parking space and wherein said first traffic management device is activated to provide an unavailable visual alert when said first zone has no free parking space.

17. The traffic management system of claim 1, wherein said traffic management device includes a solar panel electrically connected to an energy storage device to provide electrical power to said traffic management device.

18. The traffic management system of claim 1, wherein said traffic management device is comprised of a housing, wherein said housing is attached to a parking surface within said parking lot.

19. The traffic management system of claim 19, including a plurality of fasteners, wherein said housing includes a plurality of apertures and wherein said plurality of fasteners extend through said plurality of apertures into said parking surface to secure said traffic management device to said parking surface.

20. The traffic management system of claim 1, wherein said traffic management device is attached to a middle portion of a pathway within said parking lot.
